(19) United States
(12) Patent Application Publication
(10) Pub. No.: US 2024/0210103 A1
(43) Pub. Date: Jun. 27, 2024

(54) COOLING DEVICE FOR INSTANTANEOUS COOLING

(71) Applicants: GSI CO., LTD., Gimpo-si (KR); LIXIL Corporation, Tokyo (JP)

(72) Inventors: Seong Jun Choi, Incheon (KR); Sa Un Park, Seoul (KR); Hyung Mi Park, Uijeongbu-si (KR)

(73) Assignees: GSI CO., LTD., Gimpo-si (KR); LIXIL Corporation, Tokyo (JP)

(21) Appl. No.: 18/597,122

(22) Filed: Mar. 6, 2024

Related U.S. Application Data
(63) Continuation of application No. PCT/KR2022/018897, filed on Nov. 25, 2022.

(30) Foreign Application Priority Data
Nov. 25, 2021 (KR) 10-2021-0164330

(51) Int. Cl. F25D 31/00; F25D 3/02

(52) U.S. Cl. CPC F25D 31/002; F25D 3/02; F25D 2201/10

(57) ABSTRACT

The present disclosure provides a cooling device for instantaneous cooling, the cooling device including a water inflow pipe having an inlet into which water to be cooled requiring cooling flows; a housing having an outlet through which cold water cooling the water to be cooled flowing in through the inlet is discharged; a refrigerant circulation pipe provided to spirally wrap an outer surface of the housing; and a screw-shaped ice spiral formed by the refrigerant circulation pipe on an inner wall of the housing.

### CROSS-REFERENCE TO RELATED APPLICATIONS

This application is a continuation application of International Patent Application No. PCT/KR2022/018897, filed on Nov. 25, 2022, which claims the priority of KR Application No. 10-2021-0164330, filed Nov. 25, 2021, the entire contents of each of which are incorporated herein by reference.

### FIELD

The present disclosure relates to a cooling device that can produce cold water through instantaneously cooling water to be cooled that requires cooling, such as in a water purifier, a hot/cold water dispenser, or a refrigerator.

### BACKGROUND

In a water purifier, a hot/cold water dispenser, or the like, a cold water tank is used to cool room temperature water, which is raw water. The water stored in the cold water tank is cooled and stored, and then the cold water stored in the cold water tank can be discharged to the outside by a cold water discharge operation.

In a case where the cold water tank is used to cool the water to be cooled stored inside, there are disadvantages that there is a risk that the water stored inside the cold water tank is contaminated, electrical energy is required for cooling even when the cold water is not discharged, it takes time to make cold water again in a case where water stored in the cold water tank is used up, and the like.

Accordingly, there is an increasing demand for a technology that can instantaneously cool and discharge room temperature water that is water to be cooled, and to this end, the present inventors have proposed a device capable of instantaneous cooling in Korean Patent Registration No. 10-1804385.

However, the present inventors would like to propose another method of making cold water by instantaneously cooling the water to be cooled.

### SUMMARY

The present disclosure provides a cooling device for instantaneous cooling to make cold water by cooling water to be cooled flowed in from the outside within a short period of time.

The present disclosure provides a cooling device for instantaneous cooling, the cooling device including a water inflow pipe having an inlet into which water to be cooled requiring cooling flows; a housing having an outlet through which cold water cooling the water to be cooled flowing in through the inlet is discharged; a refrigerant circulation pipe provided to spirally wrap an outer surface of the housing; and a screw-shaped ice spiral formed by the refrigerant circulation pipe on an inner wall of the housing.

The cooling device according to an embodiment of the present disclosure can make cold water by cooling the water to be cooled flowed in from the outside in a short period of time by flowing along the spiral ice.

### BRIEF DESCRIPTION OF THE DRAWINGS

FIG. 1 is a view showing an appearance of a cooling device according to an embodiment of the present disclosure.

FIG. 2 is a view showing a longitudinal cross-section of the cooling device according to an embodiment of the present disclosure.

FIG. 3 is a view showing a shape in which a fluid flows along a flow path in the cooling device of FIG. 2.

FIG. 4 is a view showing a longitudinal cross-section of a cooling device according to another embodiment of the present disclosure.

FIG. 5 is a view showing a shape in which a fluid flows along a flow path in the cooling device of FIG. 4.

FIG. 6 is a view showing a cross-section of the cooling device of FIG. 4.

FIG. 7 is a view showing a shape in which a cover member according to an embodiment of the present disclosure is combined.

FIG. 8 is a view showing an appearance of a cooling device according to another embodiment of the present disclosure.

FIG. 9 is a view showing a longitudinal cross-section of the cooling device according to another embodiment of the present disclosure.

FIGS. 10 and 11 are views showing an air hole of a cooling device according to another embodiment of the present disclosure.

FIG. 12 is a view showing a flow path through which internal air of a cooling device according to another embodiment of the present disclosure is exhausted to the outside along an air hole.

### DETAILED DESCRIPTION

Hereinafter, embodiments disclosed in the present specification will be described in detail with reference to the attached drawings. However, identical or similar components will be assigned the same reference numbers regardless of drawing numerals, and duplicate descriptions thereof will be omitted. The suffixes “module” and “portion” for the components used in the following description are given or used interchangeably only for the ease of preparing the specification, and do not have distinct meanings or roles in themselves. In addition, in describing the embodiments disclosed in this specification, if it is determined that detailed descriptions of related known technologies may obscure the gist of the embodiments disclosed in this specification, the detailed descriptions will be omitted. In addition, it should be understood that the attached drawings are only for easy understanding of the embodiments disclosed in this specification, and the technical idea disclosed in this specification is not limited by the attached drawings, and includes all changes, equivalents or substitutes included in the gist and technical scope of the present disclosure are not limited.

When a component is said to be “connected” or “coupled” to another component, it should be understood that it may be directly connected to or coupled to another component, but other components may exist therebetween. On the other hand, when it is mentioned that a component is “directly connected” or “directly coupled” to another component, it should be understood that there are no other components therebetween.

Singular expressions include plural expressions unless the context clearly dictates otherwise.

In this specification, it should be understood that terms such as “include” or “have” are intended to indicate the presence of features, numbers, steps, operations, components, parts, or combinations thereof described in the specification, and the presence or the addition possibility of one or more other features, elements, numbers, steps, operations, components, parts, or combinations thereof are not excluded in advance.

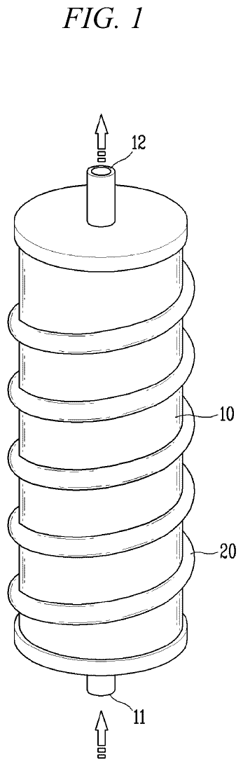

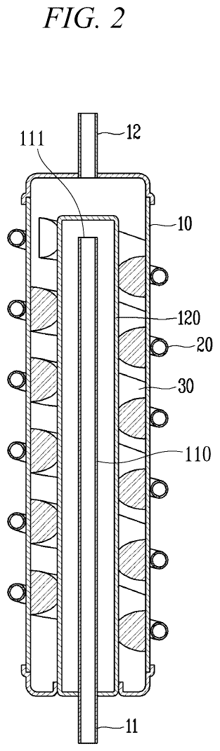

FIG. 1 is a view showing an appearance of a cooling device according to an embodiment of the present disclosure, and FIG. 2 is a view showing a longitudinal cross-section of the cooling device according to an embodiment of the present disclosure.

As shown in FIGS. 1 and 2, the cooling device for instantaneous cooling according to an embodiment of the present disclosure includes a housing 10 provided with an inlet 11 on one side and an outlet 12 on the other side, water to be cooled requiring cooling may flow into the inlet 11, and cooled cold water may be discharged through the outlet 12. In this case, the water to be cooled may be cooled by cold air formed by a refrigerant circulation pipe 20 provided to spirally wrap an outer surface of the housing 10.

However, since the components shown in FIGS. 1 and 2 are not essential, it is possible, of course, to implement a cooling device having more or fewer components.

Below, each component will be considered.

The housing 10 forms the appearance of the cooling device, in which a water inflow pipe 110 having the inlet 11 is inserted into one side, and which may have the outlet 12 on the other side through which cold water cooling the water to be cooled flowing in through the inlet 11 is discharged.

In this case, the outlet 12 may be provided on the other side of the housing 10 to form a flow path through which the cold water formed inside the housing 10 is discharged. However, the outlet 12 may be provided in the same direction as the inlet 11 depending on the number of pipes provided inside the housing 10, and in the present disclosure, the positions of the inlet 11 and the outlet 120 are not particularly limited.

The water inflow pipe 110 is shaped like a tube with openings at both end portions, and may have the inlet 11 at one end portion through which the water to be cooled flows. In this case, the inlet 11 may be provided outside the housing 10, but the present disclosure does not specifically limit this.

The other end portion of the water inflow pipe 110 inserted into one side of the housing 10 may be provided inside the housing 10. In this case, the other end portion of the water inflow pipe 110, that is, the end on the outlet 12 side, may be formed of a first opening 111, and thus the water to be cooled flowing in through the inlet 11 may flow along the water inflow pipe 110 and then be discharged through the first opening 111.

In addition, the other end portion of the water inflow pipe 110 may be provided with a cooling pipe 120 with one end portion closed and spaced apart therefrom.

The tubular cooling pipe 120 is provided inside the housing 10, and the water inflow pipe 110 may be provided to be inserted into the interior of the cooling pipe 120 along a longitudinal direction. In this case, the cooling pipe 120 with one end portion closed may be provided such that the closed one end portion covers the first opening 111 of the water inflow pipe 110.

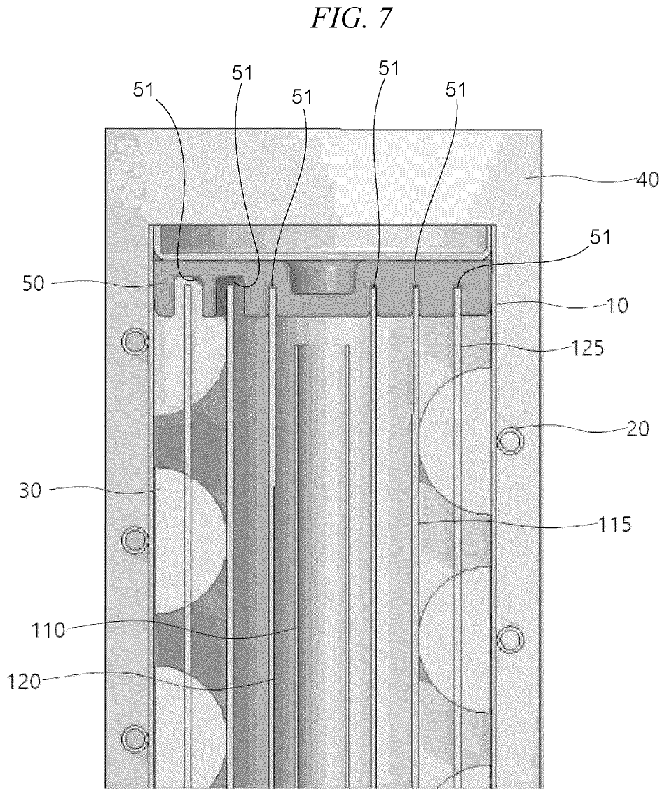

According to an embodiment of the present disclosure, the cooling pipe 120 with one end portion closed may have a separate cover member 50 combined to either one of both open end portions (see FIG. 7).

However, the separate cover member 50 according to an embodiment of the present disclosure covers and combines to at least one end portion of a plurality of concentric pipes, thereby selectively closing or opening at least one end portion of the plurality of pipes.

Specifically, a plurality of grooves 51 into which the plurality of pipes may be combined are formed on one surface of the circular or square cover member 50 corresponding to a cross-section of the pipe, and the cooling pipe 120 and a second inner pipe 125 may be completely fitted to a part of the plurality of grooves 51. Therefore, closed other end portions may be formed in the cooling pipe 120 and the second inner pipe 125.

In this case, the water inflow pipe 110 or the first inner pipe 115 is inserted into another part of the plurality of grooves 51, and at least a part of the circumference of the groove 51 into which the water inflow pipe 110 or the first inner pipe 115 is inserted is deeper than other parts. Therefore, a first opening 111 or a second opening 115a may be formed as flow paths through which a fluid may flow.

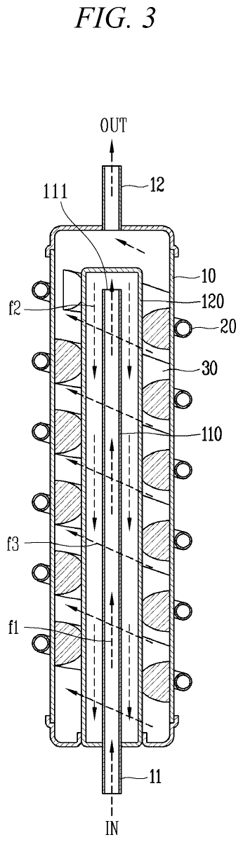

Accordingly, as shown in FIG. 3, the water to be cooled flowing in through the inlet 11 provided at one end portion of the water inflow pipe 110 may flow along the water inflow pipe 110 and be discharged through the first opening 111 at the other end portion. Accordingly, a flow direction of the water to be cooled discharged from the first opening 111 of the water inflow pipe 110 may be changed by the closed one end portion of the cooling pipe 120 covered by the water inflow pipe 110, and thereby the water to be cooled may flow along an inner wall of the cooling pipe 120.

The water to be cooled flowing along the inner wall of the cooling pipe 120 may flow in a radial direction through the first passage formed through the end portion on the inlet 11 side in an outward direction, that is, toward the inner wall of the housing 10. The water to be cooled passing through the first passage flows in the opposite direction again along the inner wall of the housing 10, and may rotate along an ice spiral 30 as will be described later.

That is, the inner wall of the housing 10 may include the screw-shaped ice spiral 30 in a form of wrapping an inner peripheral surface of the housing 10.

For this end, the refrigerant circulation pipe 20 formed along the ice spiral 30, that is, in a spiral form wrapping the housing 10, may be provided on the outer surface of the housing 10.

As the refrigerant flows inside the refrigerant circulation pipe 20, a surrounding area thereof can be cooled. As an example, among a compressor, a condenser, an evaporator, and an expansion valve that constitute a refrigeration cycle, the refrigerant circulation pipe 20 corresponds to the evaporator. The evaporator may evaporate a liquid refrigerant in low-temperature and low-pressure flowing in from the expansion valve to exchange heat with the surrounding. In other words, the compressor, which sucks the gaseous refrigerant in low-temperature and low-pressure evaporated from the evaporator, pressurizes the refrigerant to a saturation pressure corresponding to the condensation temperature so that the pressurized refrigerant can be condensed and liquefied in the condenser. The condenser heat-exchanges between the gaseous refrigerant in high-temperature and high-pressure, which is pressurized in the compressor and discharged, and the surrounding air. Therefore, the gaseous refrigerant in high temperature can be condensed and liquefied by releasing heat. The expansion valve can exert a throttling action on the liquid refrigerant in high-temperature and high-pressure, which is condensed and liquefied by the condenser, to be converted into a liquid refrigerant in low-temperature and low-pressure.

As a result, the water to be cooled flowing in through the inlet 11 is cooled on the inner peripheral surface of the housing 10 by the refrigerant circulation pipe 20 provided to spirally wrap the outer peripheral surface of the housing 10, and spiral ice, that is, the ice spiral 30 may be formed depending on the wrapped form of the refrigerant circulation pipe 20.

Accordingly, the water to be cooled flowing in the radial direction through the first passage formed at one end portion of the cooling pipe 120 may come into contact with the screw-shaped ice spiral 30 and flow while rotating according to its shape.

That is, the water to be cooled flowing in the radial direction of the cooling pipe 120 through the first passage flows along the screw-shaped ice spiral 30, that is, along a flow path f3 shown in FIG. 3, and the water to be cooled flowing along the ice spiral 30 may be guided to the outlet 12.

Here, the ice spiral 30 formed by the refrigerant circulation pipe 20 is spaced apart between adjacent ices formed along the longitudinal direction of the housing 10 in cross section, as shown in FIGS. 2 and 3, so that it is preferable to form a flow path through which the water to be cooled can flow.

In other words, it is preferable that the refrigerant circulation pipe 20 is disposed and formed on the outer peripheral surface of the housing 10 so that the ice spiral 30 is formed to be spaced apart between adjacent ices formed along the longitudinal direction of the housing 10 in the longitudinal cross-section.

Accordingly, the water to be cooled flows toward the outlet 12 in a state of coming into contact with the surface of the screw-shaped ice spiral 30. Therefore, a contact time of the water to be cooled with ice increases and a contact area with ice expands. As a result, heat exchange efficiency is increased, and the cooling efficiency of the water to be cooled can be increased.

In addition, as shown in FIGS. 2 and 3, it is preferable that the ice spiral 30 is formed to protrude in the inner direction of the housing 10, and a protruding inner end portion is formed up to the outer wall of the cooling pipe 120, or is formed up to at least a part of the inside of the cooling pipe 120, thereby being not formed inside the water inflow pipe 110.

Meanwhile, the present disclosure is not particularly limited, but the first passage (not shown) formed at one end portion of the cooling pipe 120, that is, at the end portion on the inlet 11 side, is formed through the pipe wall, and the first passage may form the flow path through which the water to be cooled can flow in the radial direction toward the inner wall of the housing 10 along the longitudinal direction of the cooling pipe 120.

In this case, the first passage may be in a form of a plurality of fine holes perforated, and accordingly, it is preferable to allow the water to be cooled passing through the first passage to be finely sprayed.

The area of the water to be cooled coming in contact with the surface of the ice spiral 30, which passes through the first passage and is finely sprayed, increases, thereby improving the cooling efficiency of the water to be cooled.

When the water to be cooled flowing in through the inlet 11 from the cooling device according to an embodiment of the present disclosure is discharged through the outlet 12, the flow path of the water to be cooled formed in the process is as shown in FIG. 3.

As shown in FIG. 3, in the cooling device according to an embodiment of the present disclosure, the water to be cooled flowing in through the inlet 11 may flow along the water inflow pipe 110 to form a flow path f1.

The water to be cooled flowing in through the inlet 11 provided at one end portion of the water inflow pipe 110 may flow along the longitudinal direction of the water inflow pipe 110 and be discharged through the first opening 111 at the other end portion. The water to be cooled discharged through the first opening may 111 flow again in the opposite direction along the longitudinal direction of the cooling pipe 120 by the cooling pipe 120 covering the other end portion, thereby forming a flow path f2.

The water to be cooled flowing on the inside along the water inflow pipe 110 and the cooling pipe 120 does not directly come into contact with the ice spiral 30, but may be roll-cooled by the cold air formed by the refrigerant circulation pipe 20 and the ice spiral 30.

Thereafter, the water to be cooled flowing in the radial direction through the first passage formed at the end portion of the cooling pipe 120 on the inlet 11 side rotates toward the outlet 12 side along the screw-shaped ice spiral 30, thereby forming the flow path f3. In this case, the water to be cooled can be intensively cooled by directly contact with the ice spiral 30.

The water to be cooled that flows into the housing 10 through the inlet 11 can be cooled in a short period of time by going through the roll-cooling and concentrated-cooling processes.

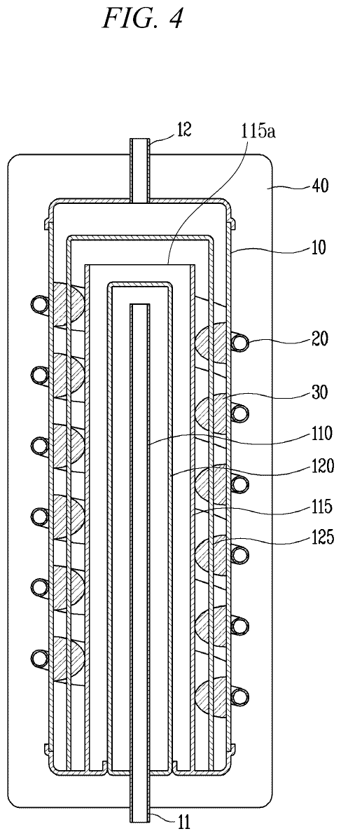

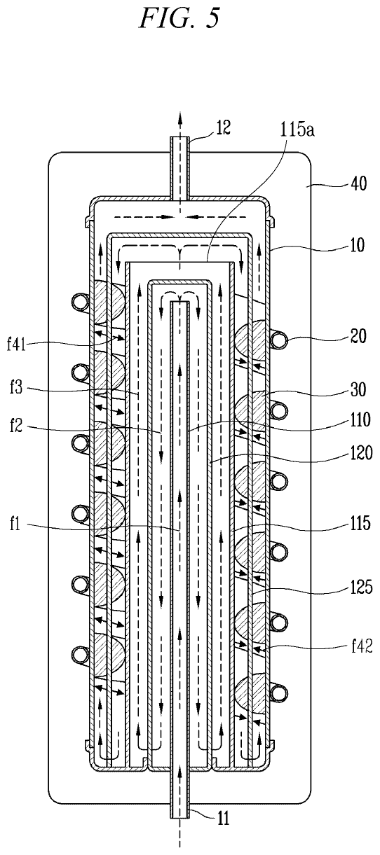

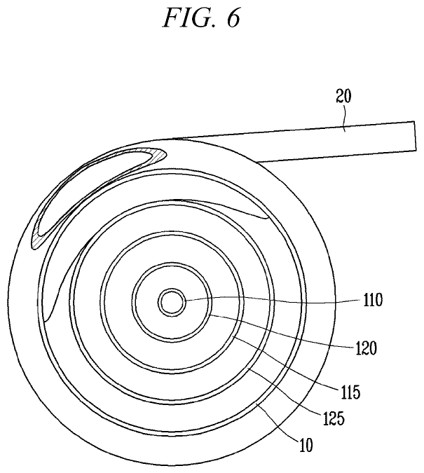

Meanwhile, FIG. 4 is a view showing a longitudinal cross-section of a cooling device according to another embodiment of the present disclosure, FIG. 5 is a view showing a shape in which a fluid flows along a flow path in the cooling device of FIG. 4, and FIG. 6 is a view showing a cross-section of the cooling device of FIG. 4.

As shown in FIGS. 4 and 6, the cooling device according to another embodiment of the present disclosure may include a first inner pipe 115 and a second inner pipe 125 provided between the cooling pipe 120 and the housing 10. In this case, the first and second inner pipes 115 and 125 is configured such that the first inner pipe 115 may sequentially form an inner shell and the second inner pipe 125 may form an outer shell.

In this case, a second opening 115a may be formed at the other end of the first inner pipe 115, that is, the end portion on the outlet 12 side, and second passage formed through the pipe wall may be provided on one end of the second inner pipe 125, that is, the end portion on the inlet 11 side. Here, the second passage, like the first passage, may also be in a form of a plurality of fine holes perforated.

In addition, it is preferable that the ice spiral 30 according to the present embodiment is formed to protrude in the inner direction on the inner wall of the housing 10, and the inner end portion of the protruding ice spiral 30 passes through the second inner pipe 125 to be formed up to the outer wall of the first inner pipe 115.

Accordingly, when the water to be cooled flowing in through the inlet 11 in the cooling device according to the present embodiment is discharged through the outlet 12, the flow path of the water to be cooled formed in the process is as shown in FIG. 5.

As shown in FIG. 5, in the cooling device according to the present embodiment, the water to be cooled flowing in through the inlet 11 may flow along the water inflow pipe 110 to form the flow path f1.

The water to be cooled flowing in through the inlet 11 provided at one end portion of the water inflow pipe 110 flows along the longitudinal direction of the water inflow pipe 110, and may be discharged through the first opening 111 provided at the other end portion. In this case, the direction of the water to be cooled is changed in the opposite direction by the closed other end portion of the cooling pipe 120, which covers the other end portion of the water inflow pipe 110, and flows along the longitudinal direction of the cooling pipe 120 to form the flow path f2.

Thereafter, the water to be cooled flowing in the radial direction through the first passage formed at the end portion of the cooling pipe 120 on the inlet 11 side may flow into the first inner pipe 115. The water to be cooled flowing in the first inner pipe 115 flows along the longitudinal direction of the first inner pipe 115 to form the flow path f3, and then may be discharged through the second opening 115a provided at the other end of the first inner pipe 115.

Here, the water to be cooled flowing inside the water inflow pipe 110, the cooling pipe 120, and the first inner pipe 115 does not directly come into contact with the ice spiral 30, but may be roll-cooled by the cold air formed by the refrigerant circulation pipe 20 and the ice spiral 30.

The water to be cooled discharged through the second opening 115a provided at the other end of the first inner pipe 115 flows along the longitudinal direction of the inner wall of the second inner pipe 125 and can rotate along the ice spiral 30 formed in the inner wall of the second inner pipe 125 to form a flow path f41. Thereafter, the water to be cooled can flow into the inner wall of the housing 10 through the second passage formed through the pipe wall at one end of the second inner pipe 125.

The water to be cooled flowing into the inner wall of the housing 10 through the second passage flows along the longitudinal direction of the inner wall of the housing 10, and rotates along the ice spiral 30 formed on the inner wall of the housing 10 to form a flow path f42, and then can be discharged into the outlet 12.

In this way, in the cooling device according to the present embodiment, after roll-cooling, since the water to be cooled can flow back and forth along the flow paths f41 and f42 in direct contact with the ice spiral 30, the cooling efficiency can be further improved by the repeated concentrated-cooling process.

In addition, since the first and second inner pipes 115 and 125, the cooling pipe 120, and the water inflow pipe 110 are provided in layers inside the housing 10, even if supercooling occurs with the refrigerant circulation pipe 20, the ice may not completely freeze up to the water inflow pipe 110.

Meanwhile, as shown in FIGS. 4 to 6, a thermal insulation material 40 may be provided on the outer surface of the housing 10 of the cooling device according to an embodiment of the present disclosure to wrap the housing 10.

The present disclosure does not specifically limit a material of the thermal insulation material 40, as long as it can form heat insulation to prevent heat from being transferred between the inside and the outside.

Meanwhile, the outlet 12 according to an embodiment of the present disclosure can discharge cold water in which the water to be cooled is cooled, but it is necessary to adjust the temperature of the cold water discharged through the outlet 12.

Accordingly, a valve (not shown) may be provided in the outlet 12 according to an embodiment of the present disclosure. In this case, the valve can mix the cold water discharged through the outlet 12 with a fluid with a temperature higher than that of the cold water, specifically the water to be cooled, and discharge mixed water whose temperature is adjusted by mixing.

In this case, a flow rate of the fluid mixed with the cold water can be adjusted by an opening/closing rate of the valve to adjust the temperature of the mixed water discharged from the valve.

Meanwhile, when the water to be cooled flows into the inlet 11 of the housing 10 according to the previous embodiment, the cold water with which the water to be cooled is cooled may be discharged through the outlet 12. However, according to another embodiment of the present disclosure, conversely, the water to be cooled can flow into the outlet 12 and the cold water can be discharged through the inlet 11.

That is, in the reverse order, rather than in the order of roll-cooling and then intensively cooling, the water to be cooled can flow in through the outlet 12 so that the water to be cooled first comes into contact with the surface of the ice spiral 30 and intensively cooled, and then the cold water can be discharged to the inlet 11 through the water inflow pipe 11. In this case, there is an effect of reducing the temperature deviation of the cold water being discharged.

Accordingly, the water to be cooled can flow into or the cooled cold water can be discharged from the inlet 11 of the housing 10, and simultaneously, the cooled cold water can be discharged from or the water to be cooled can flow into the outlet 12 of the housing 10.

In addition, the housing 10 of the cooling device according to the previous embodiments may be provided with the inlet 11 on one side and the outlet 12 on the other side, but the housing 10 of the cooling device according to another embodiment of the present disclosure may be provided with the inlet 11 and the outlet 12 on one side.

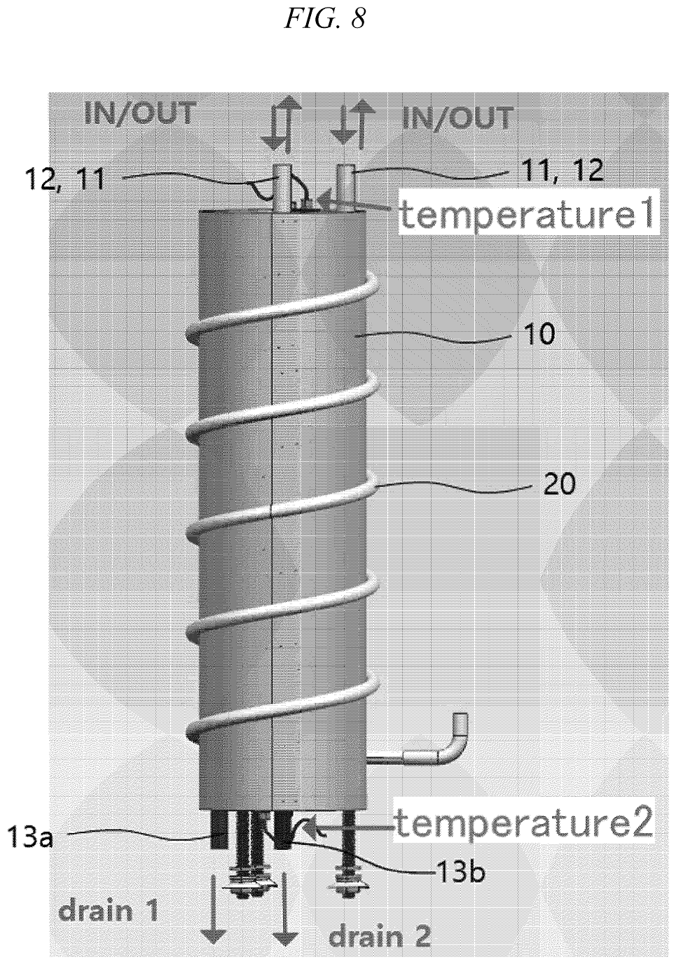

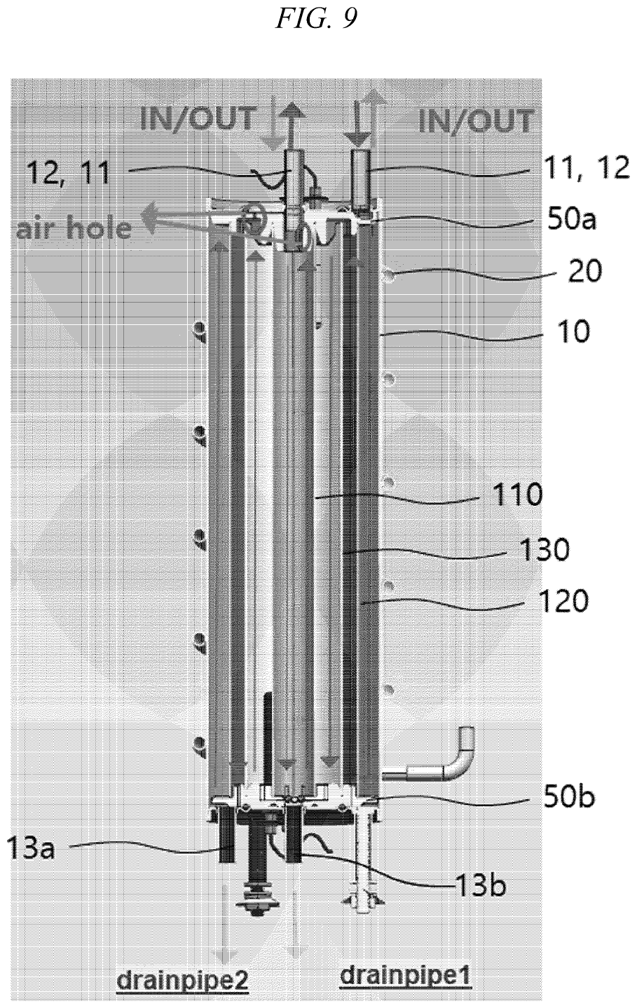

FIG. 8 is a view showing an appearance of a cooling device according to another embodiment of the present disclosure, and FIG. 9 is a view showing a longitudinal cross-section of the cooling device according to another embodiment of the present disclosure.

As shown in FIGS. 8 and 9, the water to be cooled flowing into the inlet 11 provided on one side of the housing 10 can be cooled by inducing back and forth at least once inside the housing 10, and discharged from the outlet 12 provided in the same direction as the direction in which the inlet 11 is provided.

In a case where both the inlet 11 and the outlet 12 are provided on one side of the housing 10, an odd number of third inner pipes 130 can be provided inside the housing 10 in addition to the water inflow pipe 110 and the cooling pipe 120.

As a basic example, as shown in FIG. 9, the water inflow pipe 110 having the inlet 11 into which the water to be cooled flows in, the third inner pipe 130 provided to be spaced apart from the outside of the water inflow pipe 110, and the cooling pipe 120 provided to be spaced apart from the outside of the third inner pipe 130 may be provided inside the housing 10.

Accordingly, the water to be cooled flowing along the water inflow pipe 110, the third inner pipe 130, and the cooling pipe 120 can be roll-cooled, and be rotated along the ice spiral 30 formed in a screw shape on the inner wall of the housing 10 to be intensively cooled, and then be discharged through the outlet 12 provided outside the cooling pipe 120.

As described above, in a case where the water to be cooled flows into the outlet 12, in the reverse order, the water to be cooled can be rotated along the ice spiral 30 formed in the screw shape on the inner wall of the housing 10, be roll-cooled, and then flow along the cooling pipe 120, the third inner pipe 130, and the water inflow pipe 110 to be intensively cooled, and then be discharged through the inlet 11 of the water inflow pipe 110.

In this way, the water inflow pipe 110, the third inner pipe 130, and the cooling pipe 120 are provided inside the housing 10. In this case, in order to form a flow of the water to be cooled as shown in FIG. 9, at least one of cover members 50a and 50b may be provided to selectively block one end or the other end of at least one of the water inflow pipe 110, the third inner pipe 130, and the cooling pipe 120.

In addition, according to an embodiment of the present disclosure, the housing 10 may include at least one air hole to exhaust the air filled inside to the outside, and according to a preferred embodiment, at least one air hole may be formed in the cover members 50a and 50b.

As an example, in a case where the cooling water flows into the housing 10 and is pressurized, the air inside the housing 10 may be exhausted to the outside through the air hole.

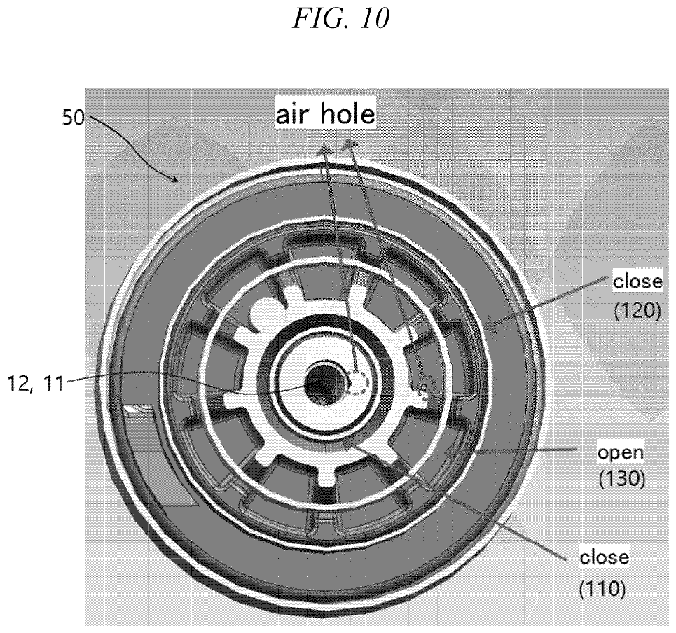

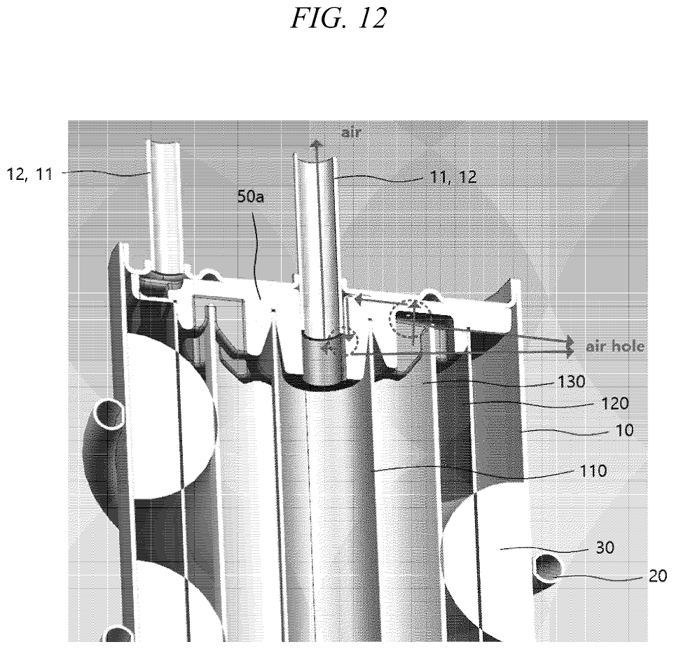

In this case, for the air hole, according to a specific embodiment, as shown in FIGS. 10 to 12, at least one air hole may be provided in the cover member 50a provided around the inlet 11 or the outlet 12 of the water inflow pipe 110.

Accordingly, when the air inside the housing 10 exhausts to the outside through the air hole, it can exhausts through the inlet 11 or the outlet 12 located around it.

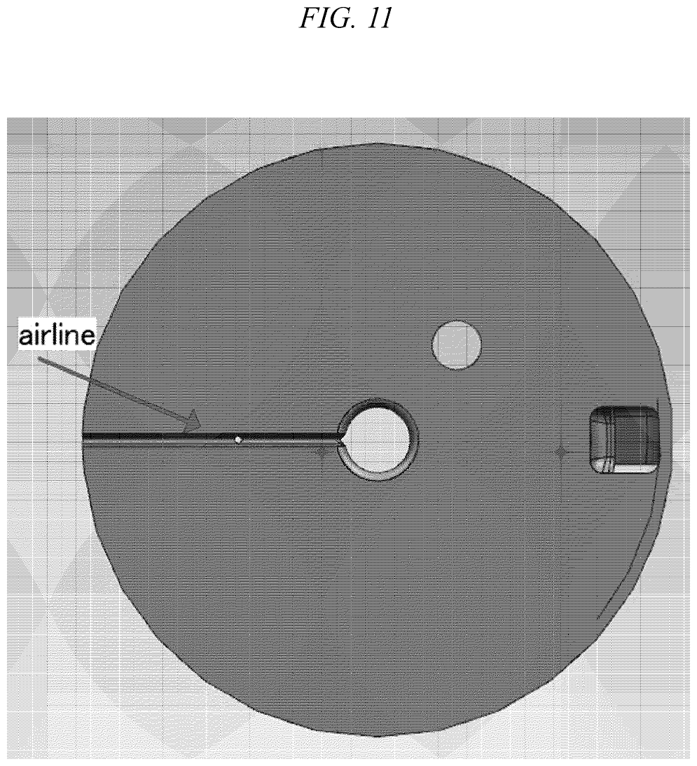

In this case, according to a more preferred embodiment, a plurality of air holes may be provided in the cover member 50a, and the plurality of air holes can be connected with an airline in the form of a groove or conduit as a passage through which air can flow therebetween them, as shown in FIG. 11.

That is, the air inside the housing 10 can be exhausted to the outside along the air hole and airline, and through the inlet 11 or the outlet 12.

Meanwhile, the housing 10 according to an embodiment of the present disclosure may be provided with at least one of drain pipes 13a and 13b for discharging the water stored inside to the outside, as shown in FIGS. 8 and 9.

At least one of drain pipes 13a and 13b is provided to enable communication between the inside and the outside at any position of the housing 10, so that the water stored inside the housing 10 can be discharged to the outside when the valve is opened.

Above, preferred embodiments of the present disclosure have been described in detail with reference to the drawings. The description of the present disclosure is for illustrative purposes, and those skilled in the art will understand that the present disclosure can be easily modified into other specific forms without changing its technical idea or essential features.

Accordingly, the scope of the present disclosure is indicated by the claims described later rather than the detailed description above, and it must be interpreted that all changes or modified forms derived from the meaning and scope of the claims and their equivalent concepts are included in the scope of the present disclosure.

What is claimed is:

1. A cooling device for instantaneous cooling, the cooling device comprising:
a water inflow pipe having an inlet into which water to be cooled requiring cooling flows;
a housing having an outlet through which cold water cooling the water to be cooled flowing in through the inlet is discharged;
a refrigerant circulation pipe provided to spirally wrap an outer surface of the housing; and
a screw-shaped ice spiral formed by the refrigerant circulation pipe on an inner wall of the housing.

2. The cooling device for instantaneous cooling according to claim 1, further comprising:
a cooling pipe provided inside the housing, and provided into which the water inflow pipe is inserted along a longitudinal direction,
wherein the ice spiral is not formed inside the water inflow pipe or the cooling pipe.

3. The cooling device for instantaneous cooling according to claim 1, further comprising:
a first passage formed through toward the inner wall of the housing at one end portion of the cooling pipe,
wherein the first passage has a plurality of fine holes perforated.

4. The cooling device for instantaneous cooling according to claim 1, wherein the water to be cooled flowing inside the water inflow pipe and the cooling pipe is roll-cooled, and the water to be cooled rotating along the ice spiral is intensively cooled on an outside of the cooling pipe.

5. The cooling device for instantaneous cooling according to claim 1, further comprising:
first and second inner pipes provided between the cooling pipe and the housing,
wherein the water to be cooled flows in through the inlet provided at one end of the water inflow pipe, and is discharged through a first opening provided at the other end of the water inflow pipe, a direction of the water to be cooled discharged to the first opening is changed by the closed other end portion of the cooling pipe, the water to be cooled flows along a longitudinal direction of the cooling pipe, and then flows into the first inner pipe,
the water to be cooled flowing into the first inner pipe flows along the longitudinal direction of the first inner pipe, and then is discharged through a second opening provided at the other end of the first inner pipe,
the water to be cooled discharged through the second opening flows along the longitudinal direction of an inner wall of the second inner pipe, rotates along the ice spiral, and then flows into the inner wall of the housing through a second passage formed through one end of the second inner pipe, and
the water to be cooled flowing into the inner wall of the housing flows along the longitudinal direction of the inner wall of the housing, rotates along the ice spiral, and then is discharged into the outlet.

6. The cooling device for instantaneous cooling according to claim 5, wherein the second passage has a plurality of fine holes perforated.

7. The cooling device for instantaneous cooling according to claim 5, wherein the closed other end portion of the cooling pipe is formed by combining a separate cover member with a tubular pipe that is open at both ends.

8. The cooling device for instantaneous cooling according to claim 7, wherein the cover member is configured such that the cooling pipe and the second inner pipe are fitted into a plurality of grooves that are concentrically provided to be combined to form the closed other end portion in the cooling pipe and the second inner pipe.

9. The cooling device for instantaneous cooling according to claim 8, wherein the cover member is configured such that a part of the plurality of grooves has a deep depth on at least a part of a circumference to form a flow path through which a fluid flows in a radial direction.

10. The cooling device for instantaneous cooling according to claim 1, further comprising:
a thermal insulation material provided on the outer surface of the housing to wrap the housing.

11. The cooling device for instantaneous cooling according to claim 1, further comprising:
a valve provided in the outlet,
wherein the valve mixes cold water discharged through the outlet with a fluid having a higher temperature than that of the cold water, and discharges mixed water of which a temperature is adjusted by mixing.

12. The cooling device for instantaneous cooling according to claim 1, wherein the water to be cooled flows into the outlet, and cold water is discharged through the inlet.

13. The cooling device for instantaneous cooling according to claim 12, wherein the water to be cooled flowing in through the outlet rotates along the ice spiral and is roll-cooled.

14. The cooling device for instantaneous cooling according to claim 1, wherein the inlet and the outlet are provided on one side of the housing in the same direction.

15. The cooling device for instantaneous cooling according to claim 14, wherein the housing includes the water inflow pipe having the inlet through which the water to be cooled flows in, a third inner pipe provided to be spaced apart from an outside of the water inflow pipe, and a cooling pipe provided to be spaced apart from an outside of the third inner pipe, and the outlet through which cold water is discharged is provided on an outside of the cooling pipe.

16. The cooling device for instantaneous cooling according to claim 15, wherein the water to be cooled flows into the outlet, and the cold water is discharged through the inlet.

17. The cooling device for instantaneous cooling according to claim 15, wherein at least one cover member, which selectively blocks one end or the other end of at least one of the water inflow pipe having a tubular shape with both ends open, the third inner pipe, and the cooling pipe, is provided on at least one side of the housing.

18. The cooling device for instantaneous cooling according to claim 17, wherein the cover member provided around the inlet or the outlet includes at least one air hole to allow inside air to be exhausted to the outside.
